(19) United States
(12) Patent Application Publication
(10) Pub. No.: US 2020/0083558 A1
(43) Pub. Date: Mar. 12, 2020

(54) LITHIUM-ION RECHARGEABLE BATTERY, BATTERY STRUCTURE OF LITHIUM-ION RECHARGEABLE BATTERY AND METHOD FOR PRODUCING LITHIUM-ION RECHARGEABLE BATTERY

(71) Applicants: SHOWA DENKO K.K., Tokyo (JP); SHOWA DENKO PACKAGING CO., LTD., Isehara-shi, Kanagawa (JP)

(72) Inventors: Akira SAKAWAKI, Ichihara-shi, Chiba (JP); Takaki YASUDA, Ichihara-shi, Chiba (JP); Koji MINAMITANI, Isehara-shi, Kanagawa (JP)

(73) Assignees: SHOWA DENKO K.K., Tokyo (JP); SHOWA DENKO PACKAGING CO., LTD., Isehara-shi, Kanagawa (JP)

(21) Appl. No.: 16/469,004

(22) PCT Filed: Nov. 1, 2017
(86) PCT No.: PCT/JP2017/039576

§ 371 Date: Jun. 12, 2019

(30) Foreign Application Priority Data
Dec. 14, 2016 (JP) 2016-242379
May 11, 2017 (JP) 2017-094350

(51) Int. Cl. H01M 10/0525; H01M 10/0562; H01M 2/26; H01M 10/44

(52) U.S. Cl. CPC H01M 10/0525; H01M 10/44; H01M 2/26; H01M 10/0562

(57) ABSTRACT

A lithium-ion rechargeable battery (1) includes a battery part (100) which performs charging and discharging using lithium ions, and a shell (30) for housing the battery part (100) in the interior thereof. The battery part (100) is configured by laminating: a first battery part (10) formed by laminating a first positive electrode layer (11), a first solid electrolyte layer (12), a first negative electrode layer (13) and a first negative electrode collector layer (14); and a second battery part (20) formed by laminating a second positive electrode layer (21), a second solid electrolyte layer (22), a second negative electrode layer (23) and a second negative electrode collector layer (24). In the shell (30), the first battery part (10) and the second battery part (20) are connected in series.

### TECHNICAL FIELD

The present invention relates to a lithium-ion rechargeable battery, a battery structure of the lithium-ion rechargeable battery and a method for producing the lithium-ion rechargeable battery.

### BACKGROUND ART

In Patent Document 1, a lithium-ion rechargeable battery is described, which is provided with: a battery part including a positive electrode containing a positive-electrode active material, a negative electrode containing a negative-electrode active material, and an electrolyte having lithium-ion conductivity and interposed between the positive electrode and the negative electrode; and a shell that houses the battery part to seal the battery part against outside air or the like.

Moreover, in Patent Document 2, it is described that a solid electrolyte made of an inorganic material is used as the electrolyte, and all of the negative electrode, the solid electrolyte and the positive electrode are configured with thin films.

### CITATION LIST

### Patent Literature

Patent Document 1: Japanese Patent Application Laid-Open Publication No. 2016-129091

Patent Document 2: Japanese Patent Application Laid-Open Publication No. 2013-73846

### SUMMARY OF INVENTION

### Technical Problem

Here, when a lithium-ion battery was configured by using a battery part of a thin-film type and a shell (housing portion) to house the battery part inside thereof, for obtaining a higher output voltage, it was necessary to connect plural lithium-ion batteries in series by use of connection lines or the like.

An object of the present invention is to increase an output voltage of a thin-film type lithium-ion rechargeable battery including a solid electrolyte with a simple configuration.

### Solution to Problem

A lithium-ion rechargeable battery according to the present invention includes: a battery part configured by laminating plural unit battery parts, each of the plural unit battery parts including a first polarity layer that occludes and releases a lithium ion with a first polarity, a solid electrolyte layer laminated on the first polarity layer and including an inorganic solid electrolyte having lithium-ion conductivity, and a second polarity layer laminated on the solid electrolyte layer to occlude and release a lithium ion with a second polarity, which is opposite to the first polarity; and a housing portion that houses the battery part inside thereof.

In such a lithium-ion rechargeable battery, the housing portion includes: a first laminated film including a first metal layer and a first resin layer laminated on the first metal layer to form a first exposed portion, where a part of the first metal layer is exposed, on one surface of the first metal layer, one end side of the battery part being connected to the first metal layer exposed at the first exposed portion; and a second laminated film including a second metal layer and a second resin layer laminated on the second metal layer to form a second exposed portion, where a part of the second metal layer is exposed, on one surface of the second metal layer, the other end side of the battery part being connected to the second metal layer exposed at the second exposed portion, and the second laminated film sealing the battery part with the first laminated film.

Moreover, an entire periphery of the second laminated film is positioned inside or outside of an entire periphery of the first laminated film.

Further, the plural battery parts are provided, and the plural battery parts are disposed in a matrix form inside the container portion.

Still further, in adjacent two of the unit battery parts of the battery part, the second polarity layer of one unit battery part and the first polarity layer of the other unit battery part are in direct contact with each other.

Then, the second polarity layer provided to a unit battery part positioned at an outermost layer of the battery part and the second metal layer exposed at the second exposed portion of the second laminated film are in direct contact with each other.

Moreover, from another standpoint, a battery structure of a lithium-ion rechargeable battery according to the present invention includes: a substrate having conductivity; a first battery part including a first polarity layer laminated on the substrate to occlude and release a lithium ion with a first polarity, a solid electrolyte layer laminated on the first polarity layer and including an inorganic solid electrolyte having lithium-ion conductivity, and a second polarity layer laminated on the solid electrolyte layer to occlude and release a lithium ion with a second polarity, which is opposite to the first polarity; and a second battery part including another first polarity layer laminated on the second polarity layer to occlude and release a lithium ion with the first polarity, another solid electrolyte layer laminated on the another first polarity layer and including an inorganic solid electrolyte having lithium-ion conductivity, and another second polarity layer laminated on the another solid electrolyte layer to occlude and release a lithium ion with the second polarity.

Moreover, from another standpoint, a method for producing a lithium-ion rechargeable battery according to the present invention includes: a process of depositing a first polarity layer occluding and releasing a lithium ion with a first polarity on a first metal layer exposed at a first exposed portion of a first laminated film, the first laminated film including the first metal layer and a first resin layer laminated on the first metal layer to form the first exposed portion, where a part of the first metal layer is exposed, on one surface of the first metal layer; a process of depositing a solid electrolyte layer on the first polarity layer, the solid electrolyte layer containing an inorganic solid electrolyte having lithium-ion conductivity; a process of depositing a second polarity layer on the solid electrolyte layer, the second polarity layer occluding and releasing a lithium ion with a second polarity, which is opposite to the first polarity; and a process of adhering the first resin layer and a second resin layer of a second laminated film including a second metal layer and the second resin layer laminated on the second metal layer to form a second exposed portion, where a part of the second metal layer is exposed, on one surface of the second metal layer in a state where the second laminated film is disposed to cause the second metal layer exposed at the second exposed portion to face the second polarity layer, wherein a series of the process of depositing the first polarity layer, the process of depositing the solid electrolyte layer and the process of depositing the second polarity layer is repeated plural times.

In such a method for producing lithium-ion rechargeable battery, each of the first polarity layer, the solid electrolyte layer and the second polarity layer is deposited by a sputtering method.

Moreover, in the deposition by the sputtering method, discharge and non-discharge are repeatedly performed in a short time.

### Advantageous Effects of Invention

According to the present invention, it is possible to increase an output voltage of a thin-film type lithium-ion rechargeable battery including a solid electrolyte with a simple configuration.

### BRIEF DESCRIPTION OF DRAWINGS

FIGS. 1A and 1B are diagrams for illustrating an overall configuration of a lithium-ion rechargeable battery to which Exemplary embodiment 1 is applied;

FIG. 2 is a II-II cross-sectional view of FIG. 1A;

FIGS. 3A and 3B are perspective views of a first laminated film viewed from a front surface side and a back surface side;

FIG. 4 is a flowchart for illustrating a method for producing the lithium-ion rechargeable battery;

FIG. 5 is a front elevational view of a lithium-ion rechargeable battery 1 to which Exemplary embodiment 2 is applied;

FIG. 6 is a VI-VI cross-sectional view of FIG. 5;

FIG. 7 is a diagram for illustrating a modified example of Exemplary embodiment 1, which is a II-II cross-sectional view of FIG. 1A; and

FIG. 8 is a diagram for illustrating a modified example of Exemplary embodiment 2, which is a VI-VI cross-sectional view of FIG. 5.

### DESCRIPTION OF EMBODIMENTS

Hereinafter, exemplary embodiments according to the present invention will be described in detail with reference to attached drawings. Note that, the size, thickness or the like of each component in the drawings referenced in the following description will differ from the actual dimension in some cases.

### Exemplary Embodiment 1

### [Configuration of Lithium-Ion Rechargeable Battery]

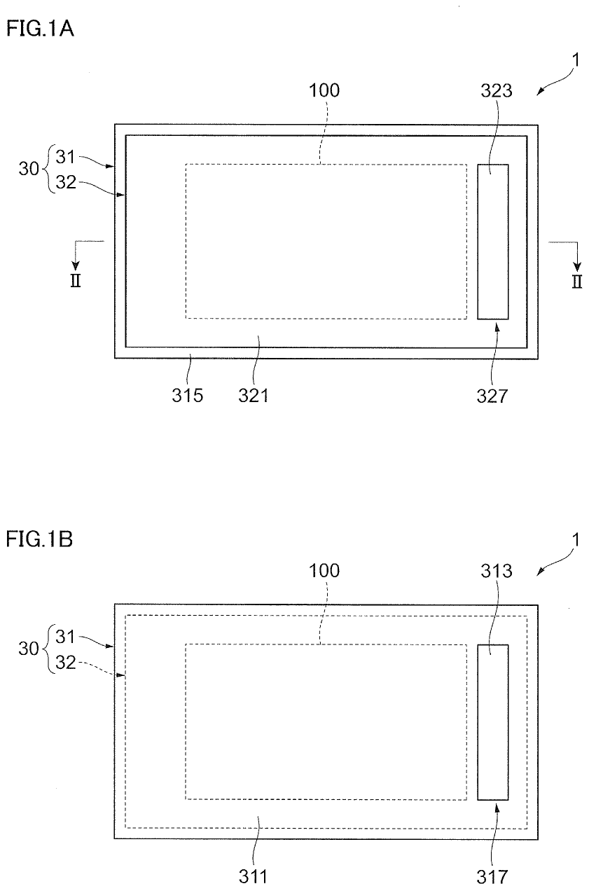

FIGS. 1A and 1B are diagrams for illustrating an overall configuration of a lithium-ion rechargeable battery 1 to which Exemplary embodiment 1 is applied. Here, FIG. 1A is a diagram in which the lithium-ion rechargeable battery 1 is viewed from the front, and FIG. 1B is a diagram in which the lithium-ion rechargeable battery 1 is viewed from the back.

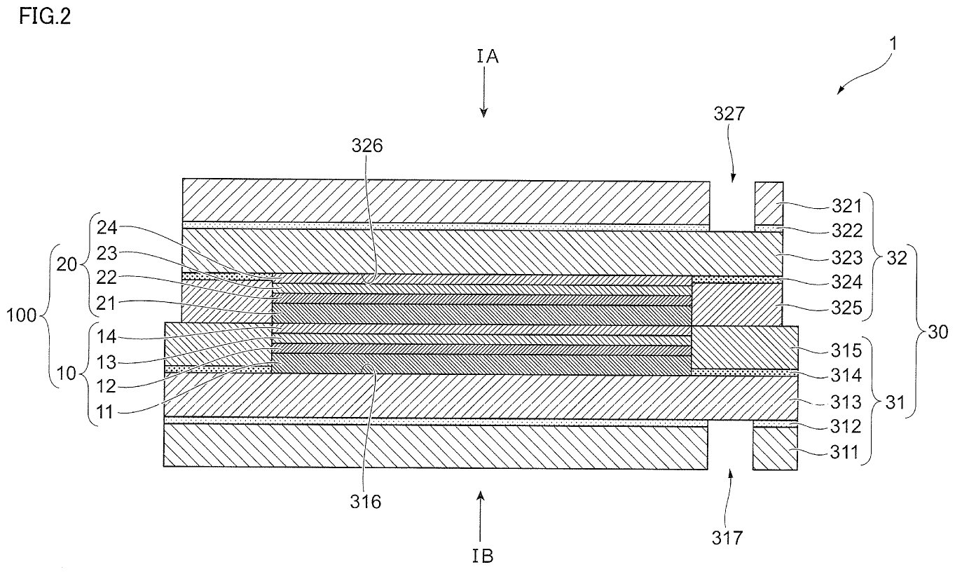

Moreover, FIG. 2 shows a II-II cross-sectional view of FIG. 1A, namely, a longitudinal section of the lithium-ion rechargeable battery 1. Note that FIG. 1A is a diagram viewing FIG. 2 from the IA direction, and FIG. 1B is a diagram viewing FIG. 2 from the IB direction.

The lithium-ion rechargeable battery 1 of the exemplary embodiment includes: a battery part 100 that performs charge and discharge using lithium ions; and a shell 30 that seals the battery part 100 against outside air or the like by housing the battery part 100 in the interior thereof. The lithium-ion rechargeable battery 1 of the exemplary embodiment shows a rectangular-parallelepiped shape (in actuality, a card shape) as a whole.

### [Configuration of Battery Part]

First, a configuration of the battery part 100 will be described.

The battery part 100 includes a first battery part 10 and a second battery part 20 that is connected to the first battery part 10 in series by being laminated on the first battery part 10. Here, as shown in FIG. 2, an upper-side end portion of the first battery part 10 is in contact with a lower-side end portion of the second battery part 20. Moreover, the lower-side end portion of the first battery part 10 is in contact with a first metal layer 313 provided to a first laminated film 31, which will be described later. In contrast thereto, the upper-side end portion of the second battery part 20 is in contact with a second metal layer 323 provided to a second laminated film 32, which will be described later.

### [Configuration of First Battery Part]

To begin with, a configuration of the first battery part 10 will be described.

The first battery part 10 as an example of a unit battery part includes: a first positive electrode layer 11; a first solid electrolyte layer 12 laminated on the first positive electrode layer 11; a first negative electrode layer 13 laminated on the first solid electrolyte layer 12; and a first negative electrode collector layer 14 laminated on the first negative electrode layer 13. Here, the first positive electrode layer 11 positioned at one end portion (the lower side in FIG. 2) of the first battery part 10 is in contact with the first metal layer 313 provided to the first laminated film 31. In contrast thereto, the first negative electrode collector layer 14 positioned at the other end portion (the upper side in FIG. 2) of the first battery part 10 is in contact with the second positive electrode layer 21 provided to the second battery part 20.

Each constituent of the first battery part 10 will be described in more detail.

### (First Positive Electrode Layer)

The first positive electrode layer 11 as an example of a first polarity layer is not particularly limited as long as the layer is a solid thin film that contains a positive-electrode active material occluding and releasing lithium ions with a positive polarity as an example of a first polarity, and, for example, those configured with various kinds of materials, such as oxides, sulfides or phosphorus oxides containing at least one kind of metals selected from manganese (Mn), cobalt (Co), nickel (Ni), iron (Fe), molybdenum (Mo) and vanadium (V), may be used. In the exemplary embodiment, as the first positive electrode layer 11, Li₂Mn₂O₄ was used.

The thickness of the first positive electrode layer 11 can be set in the range of, for example, 10 nm or more and 40 μm or less. When the thickness of the first positive electrode layer 11 is less than 10 nm, the capacity of the first battery part 10 to be obtained becomes too small and impractical. On the other hand, when the thickness of the first positive electrode layer 11 exceeds 40 μm, it takes too much time to form the layer, and thereby, the productivity is deteriorated. In the exemplary embodiment, the thickness of the first positive electrode layer 11 was set to 600 nm.

Moreover, it does not matter whether the first positive electrode layer 11 includes crystal structures or is in the amorphous state without including the crystal structures; however, in the point that expansion and contraction associated with occluding and releasing of lithium ions are more isotropic, it is preferable that the positive electrode layer 11 is in the amorphous state.

Further, as the producing method of the first positive electrode layer 11, known deposition methods, such as various kinds of PVD (physical vapor deposition) or various kinds of CVD (chemical vapor deposition), may be used; however, in terms of production efficiency, it is desirable to use the sputtering method (sputtering). In this case, in accordance with a sputtering target to be used in forming the first positive electrode layer 11, a DC sputtering method or an RF sputtering method may be used. However, in the case where the above-described Li₂Mn₂O₄ is used as the first positive electrode layer 11, it is preferable to adopt the RF sputtering method.

### (First Solid Electrolyte Layer)

The first solid electrolyte layer 12 is not particularly limited as long as being a solid thin film composed of an inorganic material (inorganic solid electrolyte) having lithium-ion conductivity, and those configured with various kinds of materials, such as oxides, nitrides or sulfides, may be used. In the exemplary embodiment, as the first solid electrolyte layer 12, LiPON (LiₓPO_{y}N_{z}), which was obtained by replacing a part of oxygen in Li₃PO₄ with nitrogen, was used.

The thickness of the first solid electrolyte layer 12 can be set in the range of, for example, 10 nm or more and 10 μm or less. When the thickness of the first solid electrolyte layer 12 is less than 10 nm, in the obtained lithium-ion rechargeable battery 1, leakage between the first positive electrode layer 11 and the first negative electrode layer 13 is likely to occur. On the other hand, when the thickness of the first solid electrolyte layer 12 exceeds 10 μm, the moving distance of lithium ions is elongated, and thereby, the charge and discharge rate is reduced. In the exemplary embodiment, the thickness of the first solid electrolyte layer 12 was set to 200 nm.

Moreover, it does not matter whether the first solid electrolyte layer 12 includes crystal structures or is in the amorphous state without including the crystal structures; however, in the point that expansion and contraction due to heat are more isotropic, it is preferable that the solid electrolyte layer 12 is in the amorphous state.

Further, as the producing method of the first solid electrolyte layer 12, known deposition methods, such as various kinds of PVD (physical vapor deposition) or various kinds of CVD (chemical vapor deposition), may be used; however, in terms of production efficiency, it is desirable to use the sputtering method (sputtering). In this case, since many sputtering targets used in forming the first solid electrolyte layer 12 are insulating bodies, it is preferable to adopt the RF sputtering method.

### (First Negative Electrode Layer)

The first negative electrode layer 13 as an example of a second polarity layer is not particularly limited as long as the layer is a solid thin film that contains a negative-electrode active material occluding and releasing lithium ions with a negative polarity as an example of a second polarity, and, for example, carbon (C) or silicon (Si) can be used. In the exemplary embodiment, as the first negative electrode layer 13, silicon (Si) added with boron (B) was used.

The thickness of the first negative electrode layer 13 can be set in the range of, for example, 10 nm or more and 40 μm or less. When the thickness of the first negative electrode layer 13 is less than 10 nm, the capacity of the battery part 100 (the lithium-ion rechargeable battery 1) to be obtained becomes too small and impractical. On the other hand, when the thickness of the first negative electrode layer 13 exceeds 40 μm, it takes too much time to form the layer, and thereby, the productivity is deteriorated. In the exemplary embodiment, the thickness of the first negative electrode layer 13 was set to 100 nm.

Moreover, it does not matter whether the first negative electrode layer 13 includes crystal structures or is in the amorphous state without including the crystal structures; however, in the point that expansion and contraction associated with occluding and releasing of lithium ions are more isotropic, it is preferable that the negative electrode layer 13 is in the amorphous state.

Further, as the producing method of the first negative electrode layer 13, known deposition methods, such as various kinds of PVD (physical vapor deposition) or various kinds of CVD (chemical vapor deposition), may be used; however, in terms of production efficiency, it is desirable to use the sputtering method (sputtering). In this case, since many sputtering targets for forming the first negative electrode layer 13 are semiconductors, it is preferable to adopt the DC sputtering method.

### (First Negative Electrode Collector Layer)

The first negative electrode collector layer 14 is not particularly limited as long as being a solid thin film having electron conductivity, and it is possible to use, for example, metals such as titanium (Ti), aluminum (Al), copper (Cu), platinum (Pt) or gold (Au), or conductive materials containing alloys of these metals. In the exemplary embodiment, as the first negative electrode collector layer 14, titanium (Ti) was used.

The thickness of the first negative electrode collector layer 14 can be set in the range of, for example, 5 nm or more and 50 μm or less. When the thickness of the first negative electrode collector layer 14 is less than 5 nm, the power collection function is deteriorated, to thereby become impractical. On the other hand, when the thickness of the first negative electrode collector layer 14 exceeds 50 μm, it takes too much time to form the layer, and thereby, the productivity is deteriorated. In the exemplary embodiment, the thickness of the first negative electrode collector layer 14 was set to 200 nm.

Moreover, as the producing method of the first negative electrode collector layer 14, known deposition methods, such as various kinds of PVD (physical vapor deposition) or various kinds of CVD (chemical vapor deposition), may be used; however, in terms of production efficiency, it is desirable to use the sputtering method (sputtering). In this case, since the sputtering target for forming the first negative electrode collector layer 14 is a metal (Ti), it is preferable to adopt the DC sputtering method.

### [Configuration of Second Battery Part]

Subsequently, a configuration of the second battery part 20 will be described.

The second battery part 20 as an example of the unit battery part includes: a second positive electrode layer 21; a second solid electrolyte layer 22 laminated on the second positive electrode layer 21; a second negative electrode layer 23 laminated on the second solid electrolyte layer 22; and a second negative electrode collector layer 24 laminated on the second negative electrode layer 23. Here, the second positive electrode layer 21 positioned at one end portion (the lower side in FIG. 2) of the second battery part 20 is in contact with the first negative electrode collector layer 14 provided to the first battery part 10. In contrast thereto, the second negative electrode collector layer 24 positioned at the other end portion (the upper side in FIG. 2) of the second battery part 20 is in contact with the second metal layer 323 provided to the second laminated film 32.

Here, the second positive electrode layer 21, the second solid electrolyte layer 22, the second negative electrode layer 23 and the second negative electrode collector layer 24 constituting the second battery part 20 can be formed by using materials described in the first positive electrode layer 11, the first solid electrolyte layer 12, the first negative electrode layer 13 and the first negative electrode collector layer 14 constituting the above-described first battery part 10, respectively. The constituent materials, thicknesses and the like may be different between the first battery part 10 and the second battery part 20; however, it is preferable to combine the same materials and the thicknesses. In the exemplary embodiment, the configuration of the second battery part 20 is in common with the configuration of the first battery part 10. Moreover, in the exemplary embodiment, the producing method of the second battery part 20 is in common with the producing method of the first battery part 10.

Then, in the exemplary embodiment, the second positive electrode layer 21 functions as an example of a first polarity layer or another first polarity layer, the second solid electrolyte layer 22 functions as an example of a solid electrolyte layer or another solid electrolyte layer, and the second negative electrode layer 23 functions as an example of a second polarity layer or another second polarity layer.

### [Configuration of Shell]

Subsequently, a configuration of the shell 30 will be described.

The shell 30 as an example of a housing portion includes the first laminated film 31 and the second laminated film 32. The first laminated film 31 and the second laminated film 32 are disposed to face each other across the battery part 100, and the first laminated film 31 and the second laminated film 32 are thermally adhered to each other over the entire circumference around the battery part 100, to thereby seal the battery part 100. Of these, the first laminated film 31 is integrated with the battery part 100 by laminating respective layers constituting the battery part 100 (the first battery part 10 (from the first positive electrode layer 11 to the first negative electrode collector layer 14) and the second battery part 20 (from the second positive electrode layer 21 to the second negative electrode collector layer 24)) on the surface thereof located inside the shell 30 (on the upper side in FIG. 2). In contrast thereto, as to the second laminated film 32, only the second negative electrode collector layer 24 of the battery part 100 is in contact with the surface of the second laminated film 32 located inside the shell 30 (on the lower side in FIG. 2). Consequently, the battery part 100 is integrated with the second laminated film 32 via the first laminated film 31; however, though the battery part 100 and the first laminated film 31 are in the state of being in contact with each other and fixed, the battery part 100 and the second laminated film 32 are in the state of being in contact with each other but not being fixed.

### [First Laminated Film]

To begin with, the first laminated film 31 will be described.

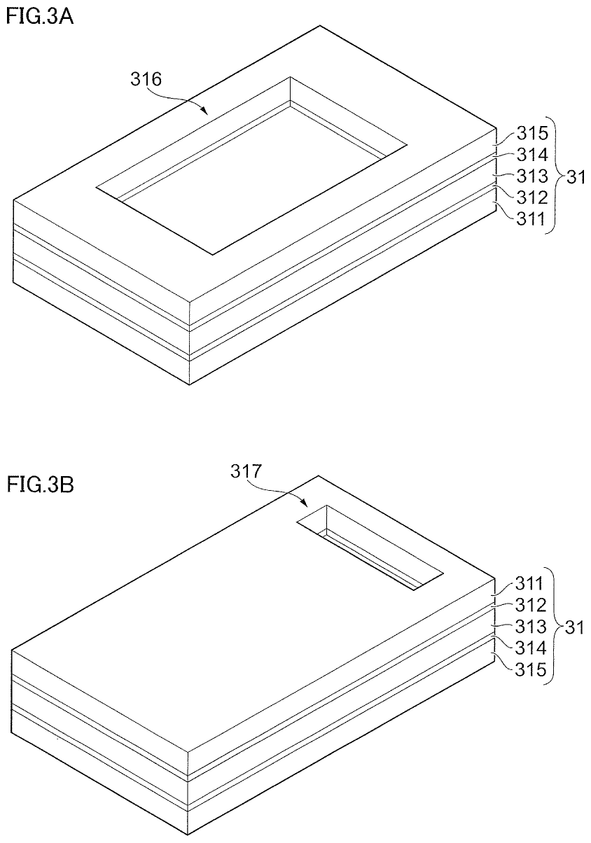

FIGS. 3A and 3B show diagrams for illustrating the configuration of the first laminated film 31: FIG. 3A shows a perspective view that is viewed from the front side (in FIG. 2, from above); and FIG. 3B shows a perspective view that is viewed from the back side (in FIG. 2, from below). Hereinafter, the configuration of the first laminated film 31 will be described with reference to FIG. 3 in addition to FIGS. 1A, 1B and 2.

The first laminated film 31 is configured by laminating a first heat-resistant resin layer 311, a first outside adhesion layer 312, the first metal layer 313, a first inside adhesion layer 314 and a first thermo-adhesive resin layer 315 in a film-like shape in this order. In other words, the first laminated film 31 is configured by bonding the first heat-resistant resin layer 311, the first metal layer 313 and the first thermo-adhesive resin layer 315 via the first outside adhesion layer 312 and the first inside adhesion layer 314.

Moreover, on a formation surface side of the first laminated film 31, on which the first thermo-adhesive resin layer 315 is formed (interior in the shell 30), there is provided a first inside exposed part 316 where a part of one surface (inside surface) of the first metal layer 313 is exposed due to absence of the first thermo-adhesive resin layer 315 and the first inside adhesion layer 314. Here, the first inside exposed part 316 as an example of a first exposed portion is provided on a center portion side of the first laminated film 31 in the surface direction, and has a rectangular shape. Then, all around the first inside exposed part 316, there are formed side walls by the first inside adhesion layer 314 and the first thermo-adhesive resin layer 315.

Further, on a formation surface side of the first laminated film 31, on which the first heat-resistant resin layer 311 is formed (outside of the shell 30), there is provided a first outside exposed part 317 where a part of the other surface (an outside surface) of the first metal layer 313 is exposed due to absence of the first heat-resistant resin layer 311 and the first outside adhesion layer 312. Here, the first outside exposed part 317 is provided on one end portion side of the first laminated film 31 in the longitudinal direction, and has a rectangular shape. Then, all around the first outside exposed part 317, there are formed side walls by the first outside adhesion layer 312 and the first heat-resistant resin layer 311.

Next, each constituent of the first laminated film 31 will be described in more detail.

### (First Heat-Resistant Resin Layer)

The first heat-resistant resin layer 311 is the outermost layer in the shell 30, and a heat-resistant resin, which has high resistance to sticking from the outside, abrasion or the like, and is not melted at the adhesive temperature in thermally adhering the first thermo-adhesive resin layer 315, is used. Here, as the first heat-resistant resin layer 311, it is preferable to use a heat-resistant resin having a melting point not less than 10° C. higher than a melting point of a thermo-adhesive resin constituting the first thermo-adhesive resin layer 315, and particularly preferable to use a heat-resistant resin having a melting point not less than 20° C. higher than the melting point of the thermo-adhesive resin. Moreover, in the exemplary embodiment, as will be described later, the first metal layer 313 also serves as the positive electrode of the battery part 100; therefore, in terms of safety, an insulating resin having high electrical resistance value is used as the first heat-resistant resin layer 311.

As the first heat-resistant resin layer 311, though not being particularly limited, examples thereof include polyamide films or polyester films, and oriented films thereof are preferably used. Among them, in terms of moldability and strength, it is particularly preferable to use a biaxially oriented polyamide film, a biaxially oriented polyester film or a multi-layered film containing these biaxially oriented films, and further, it is preferable to use a multi-layered film made by bonding the biaxially oriented polyamide film and the biaxially oriented polyester film. As the polyamide film, though not being particularly limited, examples thereof include a 6-polyamide film, a 6,6-polyamide film and an MXD polyamide film. Moreover, as the biaxially oriented polyester film, examples include a biaxially oriented polybutylene terephthalate (PBT) film and a biaxially oriented polyethylene terephthalate (PET) film. In the exemplary embodiment, as the first heat-resistant resin layer 311, a nylon film (the melting point: 220° C.) was used.

The thickness of the first heat-resistant resin layer 311 can be set in the range of 9 μm or more to 50 μm less. When the thickness of the first heat-resistant resin layer 311 is less than 9 μm, it becomes difficult to secure the sufficient strength as the shell 30 of the battery part 100. On the other hand, when the thickness of the first heat-resistant resin layer 311 exceeds 50 μm, it is not preferable because the battery becomes thick. Moreover, the production costs are increased. In the exemplary embodiment, the thickness of the first heat-resistant resin layer 311 was set to 25 μm.

### (First Outside Adhesion Layer)

The first outside adhesion layer 312 adheres the first heat-resistant resin layer 311 and the first metal layer 313. As the first outside adhesion layer 312, for example, it is preferable to use two-pack curable type polyester-urethane resin by polyester resin as a base resin and polyfunctional isocyanate compound as a curing agent, or an adhesive agent containing polyether-urethane resin. In the exemplary embodiment, as the first outside adhesion layer 312, the two-pack curable type polyester-urethane adhesive agent was used.

### (First Metal Layer)

When the shell 30 is configured by using the first laminated film 31, the first metal layer 313 as an example of a substrate is a layer having a role in preventing oxygen, moisture or the like from entering the battery part 100, which is disposed inside of the shell 30, from the outside thereof (barriering the battery part 100). Moreover, as will be described later, the first metal layer 313 further has a role as a substrate when the battery part 100 is formed by using the sputtering method, a role as a positive electrode collector layer (positive internal electrode) electrically connected to the first positive electrode layer 11 of the battery part 100, and a role as a positive external electrode electrically connected to a load provided outside (not shown). Therefore, as the first metal layer 313, metallic foil having conductivity is used.

As the first metal layer 313, though not being particularly limited, for example, aluminum foil, copper foil, nickel foil, stainless steel foil, clad foil thereof, annealed foil or unannealed foil thereof and the like are preferably used. However, considering that the first metal layer 313 is used as the substrate in forming the battery part 100 by the sputtering method, it is preferable to use stainless steel foil having high mechanical strength. Moreover, metallic foil, which is obtained by plating with conductive metals, such as nickel, tin, copper, chrome and the like, may be used. In the exemplary embodiment, as the first metal layer 313, the stainless steel foil made of SUS 304 was used.

The thickness of the first metal layer 313 can be set in the range of 20 μm or more and 200 μm or less. When the thickness of the first metal layer 313 is less than 20 μm, a pinhole or breaking is likely to occur in rolling or heat sealing in producing the metallic foil, and in addition, the electrical resistance value when being used as the electrode is increased. On the other hand, when the thickness of the first metal layer 313 exceeds 200 μm, it is not preferable because the battery becomes thick, and the production costs are increased. In the exemplary embodiment, the thickness of the first metal layer 313 was set to 30 μm.

### (First Inside Adhesion Layer)

The first inside adhesion layer 314 adheres the first metal layer 313 and the first thermo-adhesive resin layer 315. As the first inside adhesion layer 314, it is preferable to use an adhesive agent made of, for example, a polyurethane adhesive agent, an acrylic adhesive agent, an epoxy adhesive agent, a polyolefine adhesive agent, an elastomer adhesive agent, a fluorine adhesive agent or the like. Among them, it is preferable to use the acrylic adhesive agent or the polyolefine adhesive agent; in this case, the barrier properties of the first laminated film 31 against the water vapor can be improved. Moreover, it is preferable to use an adhesive agent of acid-denaturated polypropylene, polyethylene or the like. In the exemplary embodiment, as the first inside adhesion layer 314, the acid-denaturated polypropylene adhesive agent was used.

### (First Thermo-Adhesive Resin Layer)

The first thermo-adhesive resin layer 315 as an example of a first resin layer is an innermost layer in the shell 30, and, as the thermo-adhesive resin layer 315, a thermoplastic resin, which has high resistance to the materials constituting respective layers of the battery part 100 and is melted at the above-described adhesive temperature, to thereby adhere to a second thermo-adhesive resin layer 325 (details thereof will be described later) of the second laminated film 32, is used. Moreover, in the exemplary embodiment, as described above, the first metal layer 313 also serves as the positive electrode of the battery part 100; therefore, in terms of safety, an insulating resin having high electrical resistance value is used as the first thermo-adhesive resin layer 315.

As the first thermo-adhesive resin layer 315, though not being particularly limited, for example, polyethylene, polypropylene, olefin copolymer, acid denaturation and ionomer thereof and so forth are preferably used. Here, examples of the olefin copolymer include: EVA (ethylene vinyl acetate copolymer); EAA (ethylene acrylic acid copolymer); and EMAA (ethylene methacrylic acid copolymer). Moreover, as long as relationship of melting point with the first heat-resistant resin layer 311 can be satisfied, a polyamide film (for example, nylon 12) or a polyimide film can also be used. In the exemplary embodiment, as the first thermo-adhesive resin layer 315, a cast polypropylene film (the melting point: 165° C.) was used.

The thickness of the first thermo-adhesive resin layer 315 can be set in the range of 20 μm or more and 80 μm or less. When the thickness of the first thermo-adhesive resin layer 315 is less than 20 μm, pinholes are likely to occur. On the other hand, when the thickness of the first thermo-adhesive resin layer 315 exceeds 80 μm, it is not preferable because the battery becomes thick, and the production costs are increased. In the exemplary embodiment, the thickness of the first thermo-adhesive resin layer 315 was set to 30 μm.

### [Second Laminated Film]

Subsequently, the second laminated film 32 will be described.

The second laminated film 32 is configured by laminating a second heat-resistant resin layer 321, a second outside adhesion layer 322, the second metal layer 323, a second inside adhesion layer 324 and a second thermo-adhesive resin layer 325 in a film-like shape in this order. In other words, the second laminated film 32 is configured by bonding the second heat-resistant resin layer 321, the second metal layer 323 and the second thermo-adhesive resin layer 325 via the second outside adhesion layer 322 and the second inside adhesion layer 324.

Moreover, on a formation surface side of the second laminated film 32, on which the second thermo-adhesive resin layer 325 is formed (interior in the shell 30), there is provided a second inside exposed part 326 where a part of one surface (inside surface) of the second metal layer 323 is exposed due to absence of the second thermo-adhesive resin layer 325 and the second inside adhesion layer 324. Here, the second inside exposed part 326 as an example of a second exposed portion is provided on a center portion side of the second laminated film 32, and has a rectangular shape. Then, all around the second inside exposed part 326, there are formed side walls by the second inside adhesion layer 324 and the second thermo-adhesive resin layer 325.

Further, on a formation surface side of the second laminated film 32, on which the second heat-resistant resin layer 321 is formed (outside of the shell 30), there is provided a second outside exposed part 327 where a part of the other surface (outside surface) of the second metal layer 323 is exposed due to absence of the second heat-resistant resin layer 321 and the second outside adhesion layer 322. Here, the second outside exposed part 327 is provided on one end portion side of the second laminated film 32 in the longitudinal direction, and has a rectangular shape. Then, all around the second outside exposed part 327, there are formed side walls by the second outside adhesion layer 322 and the second heat-resistant resin layer 321.

As described above, the structure of the second laminated film 32 including each exposed part is almost the same as the structure of the first laminated film 31 shown in FIGS. 3A and 3B.

Next, each constituent of the second laminated film 32 will be described in more detail.

### (Second Heat-Resistant Resin Layer)

The second heat-resistant resin layer 321 is the outermost layer in the shell 30, and a heat-resistant resin, which has high resistance to sticking from the outside, abrasion or the like, and is not melted at the adhesive temperature in thermally adhering the second thermo-adhesive resin layer 325, is used. Moreover, in the exemplary embodiment, as will be described later, the second metal layer 323 also serves as the negative electrode of the battery part 100; therefore, in terms of safety, an insulating resin having high electrical resistance value is used as the second heat-resistant resin layer 321.

Then, as the second heat-resistant resin layer 321, the material described in the aforementioned first heat-resistant resin layer 311 can be used. At this time, the second heat-resistant resin layer 321 and the first heat-resistant resin layer 311 may be configured with the same material, or may be configured with different materials. Moreover, the thickness of the second heat-resistant resin layer 321 may also be the same as or different from the thickness of the first heat-resistant resin layer 311. In the exemplary embodiment, as the second heat-resistant resin layer 321, a 25 μm-thick nylon film (the melting point: 220° C.) was used.

### (Second Outside Adhesion Layer)

The second outside adhesion layer 322 adheres the second heat-resistant resin layer 321 and the second metal layer 323.

Then, as the second outside adhesion layer 322, the material described in the aforementioned first outside adhesion layer 312 can be used. At this time, the second outside adhesion layer 322 and the first outside adhesion layer 312 may be configured with the same material, or may be configured with different materials. In the exemplary embodiment, as the second outside adhesion layer 322, the two-pack curable type polyester-urethane adhesive agent was used.

### (Second Metal Layer)

When the shell 30 is formed by using the second laminated film 32, the second metal layer 323 is a layer having a role in preventing oxygen, moisture or the like from entering the battery part 100, which is disposed inside the shell 30, from the outside thereof (barriering the battery part 100). Moreover, as will be described later, the second metal layer 323 further has a role as a negative internal electrode electrically connected to the first negative electrode collector layer 14 of the battery part 100, and a role as a negative external electrode electrically connected to a load provided outside (not shown). Therefore, as the second metal layer 323, metallic foil having conductivity is used. Note that, different from the above-described first metal layer 313, the second metal layer 323 does not have a role as a substrate in forming the battery part 100 by using the sputtering method.

Then, as the second metal layer 323, the material described in the aforementioned first metal layer 313 can be used. At this time, the second metal layer 323 and the first metal layer 313 may be configured with the same material, or may be configured with different materials. Moreover, the thickness of the second metal layer 323 may also be the same as or different from the thickness of the first metal layer 313. In the exemplary embodiment, as the second metal layer 323, 40 μm-thick aluminum foil made of the A8021H—O material prescribed by JIS H4160 was used.

### (Second Inside Adhesion Layer)

The second inside adhesion layer 324 adheres the second metal layer 323 and the second thermo-adhesive resin layer 325.

Then, as the second inside adhesion layer 324, the material described in the aforementioned first inside adhesion layer 314 can be used. At this time, the second inside adhesion layer 324 and the first inside adhesion layer 314 may be configured with the same material, or may be configured with different materials. In the exemplary embodiment, as the second inside adhesion layer 324, the acid-denaturated polypropylene adhesive agent was used.

### (Second Thermo-Adhesive Resin Layer)

The second thermo-adhesive resin layer 325 as an example of a second resin layer is an innermost layer in the shell 30, and, as the second thermo-adhesive resin layer 325, a thermoplastic resin, which has high resistance to the materials constituting respective layers of the battery part 100 and is melted at the above-described adhesive temperature, to thereby adhere to the first thermo-adhesive resin layer 315 of the first laminated film 31, is used. Moreover, in the exemplary embodiment, as described above, the second metal layer 323 also serves as the negative electrode of the battery part 100; therefore, in terms of safety, an insulating resin having high electrical resistance value is used as the second thermo-adhesive resin layer 325.

Then, as the second thermo-adhesive resin layer 325, the material described in the aforementioned first thermo-adhesive resin layer 315 can be used. At this time, the second thermo-adhesive resin layer 325 and the first thermo-adhesive resin layer 315 may be configured with the same material, or may be configured with different materials as long as the melting points of the two materials are close and the materials can be melted. Moreover, the thickness of the second thermo-adhesive resin layer 325 may also be the same as or different from the thickness of the first thermo-adhesive resin layer 315. In the exemplary embodiment, as the second thermo-adhesive resin layer 325, a 30 μm-thick cast polypropylene film (the melting point: 165° C.) was used.

### [Dimensions and Positional Relationship Between First Laminated Film and Second Laminated Film]

As shown in FIG. 1, each of the first laminated film 31 and the second laminated film 32 constituting the shell 30 shows a rectangular shape when viewed from the front or the back. Then, the first laminated film 31 and the second laminated film 32 are thermally adhered in a state of being overlapped so that the short side of the first laminated film 31 and the short side of the second laminated film 32 are substantially parallel, and the long side of the first laminated film 31 and the long side of the second laminated film 32 are substantially parallel.

Here, the short-side length of the first laminated film 31 is longer than the short-side length of the second laminated film 32. Moreover, the long-side length of the first laminated film 31 is longer than the long-side length of the second laminated film 32. Then, in the shell 30, the first laminated film 31 and the second laminated film 32 are thermally adhered in a state of being overlapped so that an entire periphery of the second laminated film 32 is positioned inside of an entire periphery of the first laminated film 31.

### [Electrical Connection Structure in Lithium-Ion Rechargeable Battery]

Next, the electrical connection structure in the aforementioned lithium-ion rechargeable battery 1 will be described.

To begin with, in the battery part 100, the first battery part 10 and the second battery part 20 are electrically connected. In other words, in the battery part 100, the first positive electrode layer 11, the first solid electrolyte layer 12, the first negative electrode layer 13 and the first negative electrode collector layer 14, and the second positive electrode layer 21, the second solid electrolyte layer 22, the second negative electrode layer 23 and the second negative electrode collector layer 24 are electrically connected in this order.

Moreover, the first positive electrode layer 11 of the first battery part 10 in the battery part 100 is electrically connected to a portion, of one surface (inside surface) of the first metal layer 313 provided to the first laminated film 31, exposed to the first inside exposed part 316. In addition, a part of the other surface (outside surface) of the first metal layer 313 provided to the first laminated film 31 is exposed at the first outside exposed part 317 to the outside; the part can be electrically connected to a load (not shown) provided outside.

In contrast thereto, the second negative electrode collector layer 24 of the second battery part 20 in the battery part 100 is electrically connected to a portion, of one surface (inside surface) of the second metal layer 323 provided to the second laminated film 32, exposed to the second inside exposed part 326. In addition, a part of the other surface (outside surface) of the second metal layer 323 provided to the second laminated film 32 is exposed at the second outside exposed part 327 to the outside; the part can be electrically connected to a load (not shown) provided outside.

Then, the first metal layer 313 provided to the first laminated film 31 is electrically insulated from the second metal layer 323 provided to the second laminated film 32 by the first thermo-adhesive resin layer 315 provided to the first laminated film 31 and the second thermo-adhesive resin layer 325 provided to the second laminated film 32. At this time, in the shell 30, the first thermo-adhesive resin layer 315 of the first laminated film 31 and the second thermo-adhesive resin layer 325 of the second laminated film 32 are thermally adhered so that an entire periphery of the second laminated film 32 is positioned inside of an entire periphery of the first laminated film 31, as described above. This makes it difficult to generate a short circuit in the battery part 100 (the first battery part 10 and the second battery part 20) due to the contact between the first metal layer 313 and the second metal layer 323 exposed at an end surface of a side portion of the shell 30.

### [Method for Producing Lithium-Ion Rechargeable Battery]

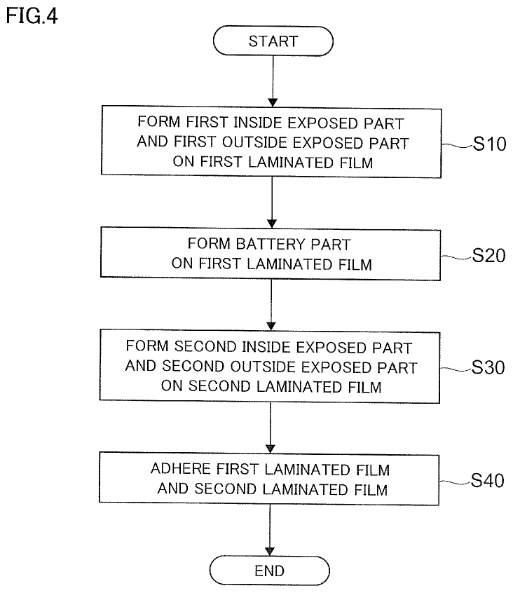

FIG. 4 is a flowchart for illustrating a method for producing the lithium-ion rechargeable battery 1 shown in FIGS. 1A and 1B, and so forth.

### (First Laminated Film Exposed Part Formation Process)

To begin with, from the first laminated film 31 formed by bonding the first heat-resistant resin layer 311, the first metal layer 313 and the first thermo-adhesive resin layer 315 via the first outside adhesion layer 312 and the first inside adhesion layer 314, a part of the first thermo-adhesive resin layer 315 and a part of the first heat-resistant resin layer 311 are removed. Consequently, in the first laminated film 31, the first inside exposed part 316 and the first outside exposed part 317 are formed (step 10).

### (Battery Part Formation Process)

Next, in the first laminated film 31 where the first inside exposed part 316 and the first outside exposed part 317 are formed, the battery part 100 is formed on the first metal layer 313 exposed at the first inside exposed part 316 by the sputtering method (step 20). Here, in step 20, on the first metal layer 313 that functions as the substrate, the first positive electrode layer 11, the first solid electrolyte layer 12, the first negative electrode layer 13 and the first negative electrode collector layer 14 are laminated in this order, to thereby obtain the first battery part 10, and thereafter, on the first negative electrode collector layer 14, the second positive electrode layer 21, the second solid electrolyte layer 22, the second negative electrode layer 23 and the second negative electrode collector layer 24 are laminated in this order, to thereby obtain the second battery part 20. Note that the details of step 20 will be described later.

### (Second Laminated Film Exposed Part Formation Process)

Moreover, from the second laminated film 32 formed by bonding the second heat-resistant resin layer 321, the second metal layer 323 and the second thermo-adhesive resin layer 325 via the second outside adhesion layer 322 and the second inside adhesion layer 324, a part of the second thermo-adhesive resin layer 325 and a part of the second heat-resistant resin layer 321 are removed. Consequently, in the second laminated film 32, the second inside exposed part 326 and the second outside exposed part 327 are formed (step 30).

### (Adhesion Process)

Subsequently, for example, into a working box filled with inert gas, such as N₂ gas or the like, the first laminated film 31 on which the battery part 100 is formed and the second laminated film 32 are introduced. Then, in the working box, the second negative electrode collector layer 24 of the battery part 100 formed on the first metal layer 313 exposed at the first inside exposed part 316 in the first laminated film 31 and the second metal layer 323 exposed at the second inside exposed part 326 in the second laminated film 32 are made to face each other. At this time, the first thermo-adhesive resin layer 315 in the first laminated film 31 and the second thermo-adhesive resin layer 325 in the second laminated film 32 face each other over entire circumference on the outside of the periphery of the battery part 100. Moreover, at this time, the first laminated film 31 and the second laminated film 32 are positioned so that the entire periphery of the second laminated film 32 is positioned inside the entire periphery of the first laminated film 31.

Thereafter, in a state where the interior of the working box is set to the negative pressure, the first thermo-adhesive resin layer 315 in the first laminated film 31 and the second thermo-adhesive resin layer 325 in the second laminated film 32 are adhered to each other over entire circumference on the outside of the periphery of the battery part 100 while being pressurized and heated (step 40). Then, due to the first thermo-adhesive resin layer 315 and the second thermo-adhesive resin layer 325 being thermally adhered, the lithium-ion rechargeable battery 1 including the battery part 100, which is formed by laminating the first battery part 10 and the second battery part 20, and the shell 30 that seals the battery part 100 is obtained.

At this time, the first metal layer 313 of the first laminated film 31 and the first positive electrode layer 11 of the battery part 100 are in a state of being joined (integrated) by deposition by the sputtering method. Moreover, the second metal layer 323 of the second laminated film 32 and the second negative electrode collector layer 24 of the battery part 100 are brought into a state of being tightly adhered to each other by thermally adhering the first thermo-adhesive resin layer 315 of the first laminated film 31 and the second thermo-adhesive resin layer 325 of the second laminated film 32 to each other under the negative pressure.

### [Method for Producing Battery Part]

Now, production procedures of the battery part 100 in the aforementioned step 20 will be described by taking specific examples.

### (Formation of First Positive Electrode Layer)

To begin with, the first laminated film 31 in which the first inside exposed part 316 and the first outside exposed part 317 were formed was placed in a deposition chamber (chamber) in a not-shown sputtering device. At this time, the first inside exposed part 316 of the first laminated film 31 was made to face the sputtering target, and portions other than the first inside exposed part 316 (portions where the first thermo-adhesive resin layer 315 exists) were masked. After the first laminated film 31 was placed in the chamber, Ar gas containing 5% O₂ gas was introduced to set the pressure in the chamber at 0.8 Pa. And then, by use of a sputtering target having a composition of Li₂Mn₂O₄, formation (deposition) of the first positive electrode layer 11 was performed on the first metal layer 313 by the RF sputtering method. At this time, the temperature of the substrate, namely, the first metal layer 313, was prevented from exceeding 150° C. by repeating discharge and standby (non-discharge) in a short time. The film composition of the first positive electrode layer 11 thus obtained was Li₂Mn₂O₄, the thickness thereof was 600 nm, and the crystal structure thereof was amorphous.

### (Formation of First Solid Electrolyte Layer)

Next, N₂ gas was introduced to set the pressure in the chamber at 0.8 Pa. And then, by use of a sputtering target having a composition of Li₃PO₄, formation (deposition) of the first solid electrolyte layer 12 was performed on the first positive electrode layer 11 by the RF sputtering method. At this time, same as the formation of the first positive electrode layer 11, the temperature of the substrate, namely, the first metal layer 313 was prevented from exceeding 150° C. by repeating discharge and standby (non-discharge) in a short time. The film composition of the first solid electrolyte layer 12 thus obtained was LiPON, the thickness thereof was 200 nm, and the crystal structure thereof was amorphous.

### (Formation of First Negative Electrode Layer)

Subsequently, Ar gas was introduced to set the pressure in the chamber at 0.8 Pa. And then, by use of a sputtering target composed of silicon (Si) doped with boron (B) (a P-type Si sputtering target), formation (deposition) of the first negative electrode layer 13 was performed on the first solid electrolyte layer 12 by the DC sputtering method. At this time, same as the case of the first positive electrode layer 11, the temperature of the substrate, namely, the first metal layer 313 was prevented from exceeding 150° C. by repeating discharge and standby (non-discharge) in a short time. The film composition of the first negative electrode layer 13 thus obtained was Si doped with B, the thickness thereof was 100 nm, and the crystal structure thereof was amorphous.

### (Formation of First Negative Electrode Collector Layer)

Further, in a state where Ar gas was introduced to set the pressure in the chamber at 0.8 Pa, by use of a sputtering target composed of titanium (Ti), formation (deposition) of the first negative electrode collector layer 14 was performed on the first negative electrode layer 13 by the DC sputtering method. At this time, same as the case of the first positive electrode layer 11, the temperature of the substrate, namely, the first metal layer 313 was prevented from exceeding 150° C. by repeating discharge and standby (non-discharge) in a short time. The film composition of the first negative electrode collector layer 14 thus obtained was Ti, and the thickness thereof was 200 nm.

### (Formation of Second Positive Electrode Layer)

With the same procedures as those of the above-described first positive electrode layer 11, formation (deposition) of the second positive electrode layer 21 was performed. The film composition of the obtained second positive electrode layer 21 was Li₂Mn₂O₄, the thickness thereof was 600 nm, and the crystal structure thereof was amorphous.

### (Formation of Second Solid Electrolyte Layer)

With the same procedures as those of the above-described first solid electrolyte layer 12, formation (deposition) of the second solid electrolyte layer 22 was performed. The film composition of the obtained second solid electrolyte layer 22 was LiPON, the thickness thereof was 200 nm, and the crystal structure thereof was amorphous.

### (Formation of Second Negative Electrode Layer)

With the same procedures as those of the above-described first negative electrode layer 13, formation (deposition) of the second negative electrode layer 23 was performed. The film composition of the obtained second negative electrode layer 23 was Si doped with B, the thickness thereof was 100 nm, and the crystal structure thereof was amorphous.

### (Formation of Second Negative Electrode Collector Layer)

With the same procedures as those of the above-described first negative electrode collector layer 14, formation (deposition) of the second negative electrode collector layer 24 was performed. The film composition of the obtained second negative electrode collector layer 24 was Ti, and the thickness thereof was 200 nm.

By the above-described procedures, on the first metal layer 313 exposed at the first inside exposed part 316 of the first laminated film 31, the battery part 100, which was configured by laminating the first battery part 10 and the second battery part 20, was formed. Then, the first laminated film 31 on which the battery part 100 was formed was taken out of the chamber. Here, in the exemplary embodiment, since each layer constituting the battery part 100 is formed by the sputtering method on the first metal layer 313 of the first laminated film 31, the first laminated film 31 and the battery part 100 are integrated by the first metal layer 313 and the first positive electrode layer 11.

Then, in the exemplary embodiment, the first metal layer 313 and the battery part 100 (the first battery part 10 and the second battery part 20) correspond to the battery structure of the lithium-ion rechargeable battery 1.

### Conclusion of Exemplary Embodiment 1

As described above, according to the exemplary embodiment, the battery part 100 was configured by laminating the first battery part 10 and the second battery part 20 that were constituted by thin films, and the battery part 100 was housed inside the shell 30. Moreover, in the exemplary embodiment, on the first metal layer 313 of the first laminated film 31 constituting the shell 30, the battery part 100, which was configured by laminating the first battery part 10 and the second battery part 20 that were constituted by the thin films, was formed. Consequently, since the first battery part 10 and the second battery part 20 can be connected in series inside the shell 30, it is possible to increase the output voltage of the thin-film type lithium-ion rechargeable battery 1 including a solid electrolyte (the first solid electrolyte layer 12 and the second solid electrolyte layer 22) with a simple configuration.

### Exemplary Embodiment 2

In Exemplary embodiment 1, the lithium-ion rechargeable battery 1 was configured by housing a single (one) battery part 100 (lamination of the first battery part 10 and the second battery part 20) in the shell 30. In contrast thereto, in the exemplary embodiment, plural battery parts 100 are housed inside of the shell 30 and the plural battery parts 100 are connected in parallel by use of the shell 30, to thereby configure a lithium-ion rechargeable battery 1 having a larger capacity. Note that, in the exemplary embodiment, those similar to Exemplary embodiment 1 are assigned with same reference signs, and detailed descriptions thereof will be omitted.

### [Configuration of Lithium-Ion Rechargeable Battery]

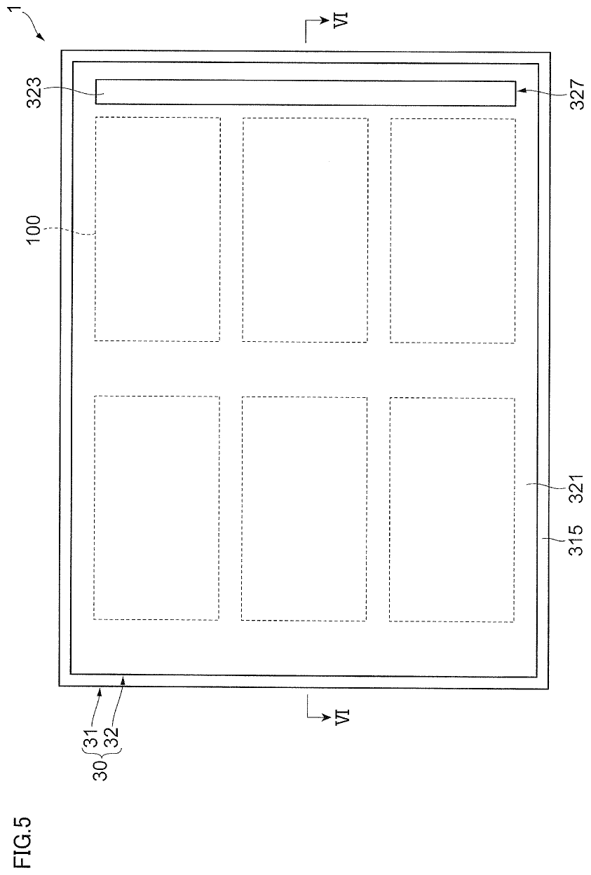

FIG. 5 is a diagram for illustrating an overall configuration of the lithium-ion rechargeable battery 1 to which Exemplary embodiment 2 is applied. Here, FIG. 5 is a diagram in which the lithium-ion rechargeable battery 1 is viewed from the front.

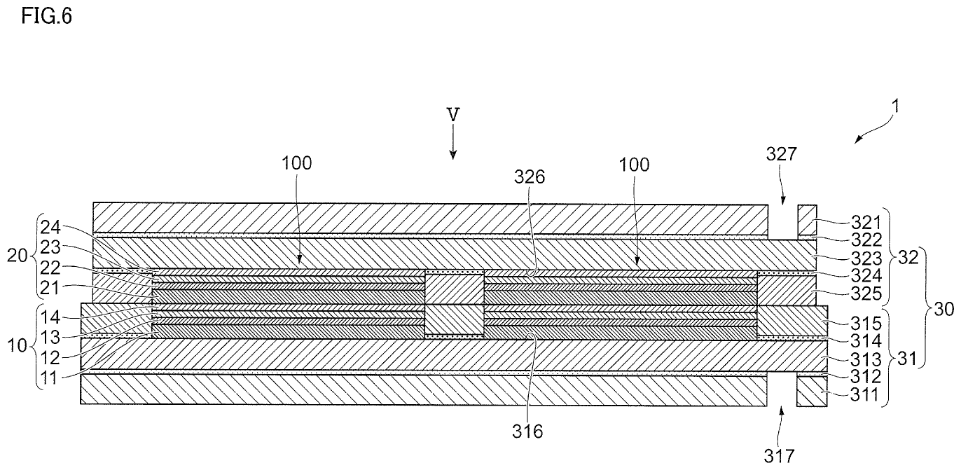

Moreover, FIG. 6 shows a VI-VI cross-sectional view of FIG. 5, namely, a longitudinal section of the lithium-ion rechargeable battery 1. Note that FIG. 5 is a diagram viewing FIG. 6 from the V direction.

The lithium-ion rechargeable battery 1 of the exemplary embodiment includes: plural (six here) battery parts 100 that perform charge and discharge using lithium ions; and a shell 30 that seals the plural battery parts 100 against outside air or the like by housing the plural battery parts 100 in the interior thereof. The lithium-ion rechargeable battery 1 of the exemplary embodiment also shows a rectangular-parallelepiped shape (in actuality, a card shape) as a whole.

Then, the six battery parts 100 are, as shown in FIG. 5, disposed in a form of a matrix in which there are three rows in the short side and two rows in the long side of the shell 30 so that the long side of the shell 30 corresponds to the long side of each battery part 100 and the short side of the shell 30 corresponds to the short side of each battery part 100.

### [Configuration of Battery Part]

The configuration of each of the six battery parts 100 is the same as that described in Exemplary embodiment 1. In other words, each of the battery parts 100 is configured by laminating the first battery part 10, which is formed by laminating the first positive electrode layer 11, the first solid electrolyte layer 12, the first negative electrode layer 13 and the first negative electrode collector layer 14, and the second battery part 20, which is formed by laminating the second positive electrode layer 21, the second solid electrolyte layer 22, the second negative electrode layer 23 and the second negative electrode collector layer 24.

### [Configuration of Shell]

Subsequently, a configuration of the shell 30 will be described.

The shell 30 includes the first laminated film 31 and the second laminated film 32. The first laminated film 31 and the second laminated film 32 are disposed to face each other across the six battery parts 100, and the first laminated film 31 and the second laminated film 32 are adhered to each other over the entire circumference around the six battery parts 100, to thereby seal the six battery parts 100. Consequently, the basic configuration of the shell 30 is the same as that in Exemplary embodiment 1.

However, there is a difference from Exemplary embodiment 1 in that, on a formation surface side of the first laminated film 31, on which the first thermo-adhesive resin layer 315 is formed (interior in the shell 30), there are provided first inside exposed parts 316, where a part of one surface of the first metal layer 313 (inside surface) is exposed due to absence of the first thermo-adhesive resin layer 315 and the first inside adhesion layer 314, at six locations (3×2) corresponding to the six battery parts 100. Moreover, there is a difference from Exemplary embodiment 1 in that, on a formation surface side of the second laminated film 32, on which the second thermo-adhesive resin layer 325 is formed (interior in the shell 30), there are provided second inside exposed parts 326, where a part of one surface of the second metal layer 323 (inside surface) is exposed due to absence of the second thermo-adhesive resin layer 325 and the second inside adhesion layer 324, at six (3×2) locations corresponding to the six battery parts 100.

### [Electrical Connection Structure in Lithium-Ion Rechargeable Battery]

In the exemplary embodiment, the first positive electrode layer 11 of each of the six battery parts 100 is electrically connected to a portion, of one surface (inside surface) of the first metal layer 313 provided to the first laminated film 31, exposed to the first inside exposed part 316. Moreover, a part of the other surface (outside surface) of the first metal layer 313 provided to the first laminated film 31 is exposed at the first outside exposed part 317 to the outside; therefore, the part can be electrically connected to an external electrode (a positive electrode, which is not shown).

In contrast thereto, the negative electrode collector layer 24 of each of the six battery parts 100 is electrically connected to a portion, of one surface (inside surface) of the second metal layer 323 provided to the second laminated film 32, exposed to the second inside exposed part 326. Moreover, a part of the other surface (outside surface) of the second metal layer 323 provided to the second laminated film 32 is exposed at the second outside exposed part 327 to the outside; therefore, the part can be electrically connected to an external negative electrode (not shown).

### Conclusion of Exemplary Embodiment 2

As described above, in the exemplary embodiment, in addition to the effects described in Exemplary embodiment 1, it is possible to increase the capacity by connecting the plural battery parts 100 in parallel by use of the first metal layer 313 of the first laminated film 31 and the second metal layer 323 of the second laminated film 32.

### Modified Example of Exemplary Embodiment 1

In the lithium-ion rechargeable battery 1 of Exemplary embodiment 1, in the battery part 100, the first battery part 10 included the first negative electrode collector layer 14 and the second battery part 20 included the second negative electrode collector layer 24; however, the first negative electrode collector layer 14 and the second negative electrode collector layer 24 are not essential.

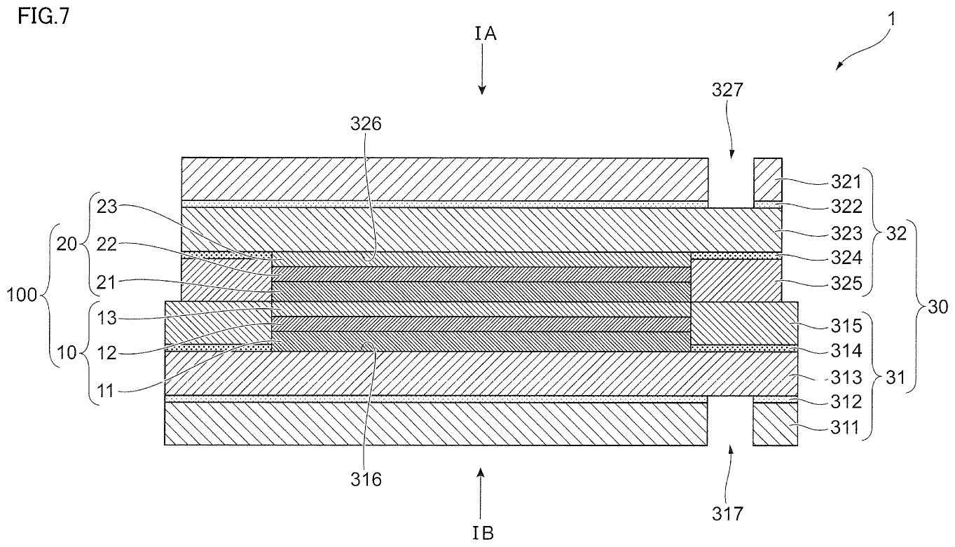

FIG. 7 is a diagram for illustrating a modified example of Exemplary embodiment 1, which is a II-II cross-sectional view of FIG. 1A.

In the modified example of Exemplary embodiment 1, the first battery part 10 constituting the battery part 100 includes: the first positive electrode layer 11; the first solid electrolyte layer 12 laminated on the first positive electrode layer 11; and the first negative electrode layer 13 laminated on the first solid electrolyte layer 12.

Moreover, the second battery part 20 constituting the battery unit 100 includes: the second positive electrode layer 21; the second solid electrolyte layer 22 laminated on the second positive electrode layer 21; and the second negative electrode layer 23 laminated on the second solid electrolyte layer 22.

In the battery part 100, the first negative electrode layer 13 provided to the first battery part 10 is in direct contact with the second positive electrode layer 21 provided to the second battery part 20. Moreover, of the battery part 100, the first positive electrode layer 11 provided to the first battery part 10 is in direct contact with the first metal layer 313 exposed to the first inside exposed part 316 of the first laminated film 31. Further, of the battery part 100, the second negative electrode layer 23 provided to the second battery part 20 is in direct contact with the second metal layer 323 exposed at the second inside exposed part 326 of the second laminated film 32.

By adopting such a configuration, as compared to the configuration described in Exemplary embodiment 1, it is possible to simplify the structure of the lithium-ion rechargeable battery 1.

### Modified Example of Exemplary Embodiment 2

In the lithium-ion rechargeable battery 1 of Exemplary embodiment 2, each of the plural first battery parts 10 included the first negative electrode collector layer 14 and each of the plural second battery parts 20 included the second negative electrode collector layer 24; however, the first negative electrode collector layer 14 and the second negative electrode collector layer 24 are not essential.

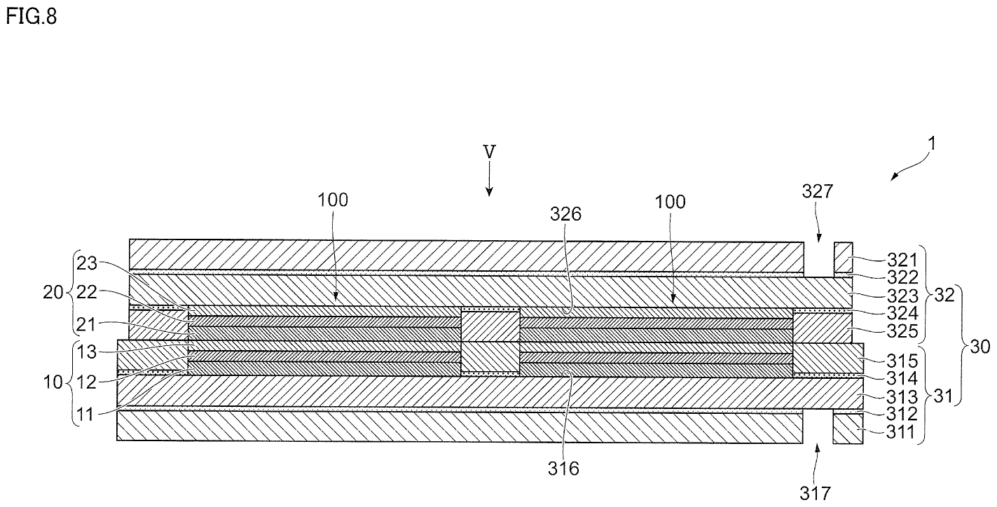

FIG. 8 is a diagram for illustrating a modified example of Exemplary embodiment 2, which is a VI-VI cross-sectional view of FIG. 5.

In the modified example of Exemplary embodiment 2, the first battery part 10 constituting each of the battery parts 100 includes: the first positive electrode layer 11; the first solid electrolyte layer 12 laminated on the first positive electrode layer 11; and the first negative electrode layer 13 laminated on the first solid electrolyte layer 12.

Moreover, the second battery part 20 constituting each of the battery parts 100 includes: the second positive electrode layer 21; the second solid electrolyte layer 22 laminated on the second positive electrode layer 21; and the second negative electrode layer 23 laminated on the second solid electrolyte layer 22.

In each of the battery parts 100, the first negative electrode layer 13 provided to the first battery part 10 is in direct contact with the second positive electrode layer 21 provided to the second battery part 20. Moreover, of each of the battery parts 100, the first positive electrode layer 11 provided to the first battery part 10 is in direct contact with the first metal layer 313 exposed to the first inside exposed part 316 of the first laminated film 31. Further, of each of the battery parts 100, the second negative electrode layer 23 provided to the second battery part 20 is in direct contact with the second metal layer 323 exposed at the second inside exposed part 326 of the second laminated film 32.

By adopting such a configuration, as compared to the configuration described in Exemplary embodiment 2, it is possible to simplify the structure of the lithium-ion rechargeable battery 1.

### <Others>

Note that, in Exemplary embodiments 1 and 2, the first battery part 10 was formed by laminating, on the first metal layer 313 of the first laminated film 31, the first positive electrode layer 11, the first solid electrolyte layer 12, the first negative electrode layer 13 and the first negative electrode collector layer 14 in this order, and the second battery part 20 was formed by laminating, on the first negative electrode collector layer 14, the second positive electrode layer 21, the second solid electrolyte layer 22, the second negative electrode layer 23 and the second negative electrode collector layer 24 in this order; however, the laminating order is not limited thereto. For example, the battery part 100 may be formed by laminating the first negative electrode layer 13, the first solid electrolyte layer 12, the first positive electrode layer 11, the second negative electrode layer 23, the second solid electrolyte layer 22 and the second positive electrode layer 21 in this order from the side of the first metal layer 313 of the first laminated film 31. In this case, the positive electrode collector layer that is in contact with the second metal layer 323 of the second laminated film 32 may be provided on the second positive electrode layer 21, but is not essential. Moreover, the positive electrode collector layer may be provided on the first positive electrode layer 11, but is not essential.

Moreover, in Exemplary embodiments 1 and 2, the first laminated film 31 constituting the shell 30 included the first heat-resistant resin layer 311; however, it is sufficient that the first laminated film 31 is at least provided with the first metal layer 313 and the first thermo-adhesive resin layer 315, and the first heat-resistant resin layer 311 is not essential. Moreover, in Exemplary embodiments 1 and 2, the second laminated film 32 constituting the shell 30 included the second heat-resistant resin layer 321; however, it is sufficient that the second laminated film 32 is at least provided with the second metal layer 323 and the second thermo-adhesive resin layer 325, and the second heat-resistant resin layer 321 is not essential.

Further, in Exemplary embodiments 1 and 2, the first laminated film 31 and the second laminated film 32 were overlapped so that the entire periphery of the second laminated film 32 was positioned inside of the entire periphery of the first laminated film 31; however, the present invention is not limited thereto. In other words, the first laminated film 31 and the second laminated film 32 may be overlapped so that the entire periphery of the second laminated film 32 is positioned outside of the entire periphery of the first laminated film 31.

Still further, in Exemplary embodiments 1, 2 and the modified examples thereof, the battery part 100 (the second negative electrode collector layer 24 or the second negative electrode layer 23) and the second laminated film 32 (the second metal layer 323) were brought into contact with each other in the state of not being fixed; however, the present invention is not limited thereto, and it may be possible to fix the positional relationship of these components by use of, for example, a conductive adhesive agent or the like.

Moreover, in Exemplary embodiments 1 and 2, the first negative electrode collector layer 14 was provided to the first battery part 10 constituting the battery part 100; however, the first negative electrode collector layer 14 is not essential, and the second positive electrode layer 21 of the second battery part 20 may be directly laminated on the first negative electrode layer 13 of the first battery part 10.

Further, in Exemplary embodiments 1 and 2, the battery part 100 was configured by laminating two unit battery parts, namely, the first battery part 10 and the second battery part 20; however, the present invention is not limited thereto, and the battery part 100 may be configured by laminating three or more unit battery parts.

Still further, in Exemplary embodiments 1 and 2, the battery part 100 was formed on the first metal layer 313 of the first laminated film 31; however, the present invention is not limited thereto, and it may be possible that the battery part 100 is formed on a conductive substrate, and thereafter, the conductive substrate and the battery part 100 are housed inside the shell 30.

### REFERENCE SIGNS LIST

1 Lithium-ion rechargeable battery
10 First battery part
11 First positive electrode layer
12 First solid electrolyte layer
13 First negative electrode layer
14 First negative electrode collector layer
20 Second battery part
21 Second positive electrode layer
22 Second solid electrolyte layer
23 Second negative electrode layer
24 Second negative electrode collector layer
30 Shell
31 First laminated film
32 Second laminated film
100 Battery part
311 First heat-resistant resin layer
312 First outside adhesion layer
313 First metal layer
314 First inside adhesion layer
315 First thermo-adhesive resin layer
316 First inside exposed part
317 First outside exposed part
321 Second heat-resistant resin layer
322 Second outside adhesion layer
323 Second metal layer
324 Second inside adhesion layer
325 Second thermo-adhesive resin layer
326 Second inside exposed part
327 Second outside exposed part

1-10. (canceled)

11. A lithium-ion rechargeable battery comprising:
a battery part configured by laminating a plurality of unit battery parts, each of the plurality of unit battery parts including a first polarity layer that occludes and releases a lithium ion with a first polarity, a solid electrolyte layer laminated on the first polarity layer and including an inorganic solid electrolyte having lithium-ion conductivity, and a second polarity layer laminated on the solid electrolyte layer to occlude and release a lithium ion with a second polarity, which is opposite to the first polarity; and
a housing portion that houses the battery part inside thereof.

12. The lithium-ion rechargeable battery according to claim 11, wherein
the housing portion comprises:
a first laminated film including a first metal layer and a first resin layer laminated on the first metal layer to form a first exposed portion, where a part of the first metal layer is exposed, on one surface of the first metal layer, one end side of the battery part being connected to the first metal layer exposed at the first exposed portion; and
a second laminated film including a second metal layer and a second resin layer laminated on the second metal layer to form a second exposed portion, where a part of the second metal layer is exposed, on one surface of the second metal layer, the other end side of the battery part being connected to the second metal layer exposed at the second exposed portion, and the second laminated film sealing the battery part with the first laminated film.

13. The lithium-ion rechargeable battery according to claim 12, wherein an entire periphery of the second laminated film is positioned inside or outside of an entire periphery of the first laminated film.

14. The lithium-ion rechargeable battery according to claim 11, wherein a plurality of the battery parts is provided, and the plural battery parts are disposed in a matrix form inside the housing portion.

15. The lithium-ion rechargeable battery according to claim 12, wherein a plurality of the battery parts is provided, and the plural battery parts are disposed in a matrix form inside the housing portion.

16. The lithium-ion rechargeable battery according to claim 13, wherein a plurality of the battery parts is provided, and the plural battery parts are disposed in a matrix form inside the housing portion.

17. The lithium-ion rechargeable battery according to claim 11, wherein, in adjacent two of the unit battery parts of the battery part, the second polarity layer of one unit battery part and the first polarity layer of the other unit battery part are in direct contact with each other.

18. The lithium-ion rechargeable battery according to claim 12, wherein, in adjacent two of the unit battery parts of the battery part, the second polarity layer of one unit battery part and the first polarity layer of the other unit battery part are in direct contact with each other.

19. The lithium-ion rechargeable battery according to claim 13, wherein, in adjacent two of the unit battery parts of the battery part, the second polarity layer of one unit battery part and the first polarity layer of the other unit battery part are in direct contact with each other.

20. The lithium-ion rechargeable battery according to claim 14, wherein, in adjacent two of the unit battery parts of the battery part, the second polarity layer of one unit battery part and the first polarity layer of the other unit battery part are in direct contact with each other.

21. The lithium-ion rechargeable battery according to claim 15, wherein, in adjacent two of the unit battery parts of the battery part, the second polarity layer of one unit battery part and the first polarity layer of the other unit battery part are in direct contact with each other.

22. The lithium-ion rechargeable battery according to claim 16, wherein, in adjacent two of the unit battery parts of the battery part, the second polarity layer of one unit battery part and the first polarity layer of the other unit battery part are in direct contact with each other.

23. The lithium-ion rechargeable battery according to claim 12, wherein the second polarity layer provided to a unit battery part positioned at an outermost layer of the battery part and the second metal layer exposed at the second exposed portion of the second laminated film are in direct contact with each other.

24. A battery structure of a lithium-ion rechargeable battery comprising:
a substrate having conductivity;
a first battery part including a first polarity layer laminated on the substrate to occlude and release a lithium ion with a first polarity, a solid electrolyte layer laminated on the first polarity layer and including an inorganic solid electrolyte having lithium-ion conductivity, and a second polarity layer laminated on the solid electrolyte layer to occlude and release a lithium ion with a second polarity, which is opposite to the first polarity; and
a second battery part including another first polarity layer laminated on the second polarity layer to occlude and release a lithium ion with the first polarity, another solid electrolyte layer laminated on the another first polarity layer and including an inorganic solid electrolyte having lithium-ion conductivity, and another second polarity layer laminated on the another solid electrolyte layer to occlude and release a lithium ion with the second polarity.

25. A method for producing a lithium-ion rechargeable battery, comprising:
a process of depositing a first polarity layer occluding and releasing a lithium ion with a first polarity on a first metal layer exposed at a first exposed portion of a first laminated film, the first laminated film including the first metal layer and a first resin layer laminated on the first metal layer to form the first exposed portion, where a part of the first metal layer is exposed, on one surface of the first metal layer;
a process of depositing a solid electrolyte layer on the first polarity layer, the solid electrolyte layer containing an inorganic solid electrolyte having lithium-ion conductivity;
a process of depositing a second polarity layer on the solid electrolyte layer, the second polarity layer occluding and releasing a lithium ion with a second polarity, which is opposite to the first polarity; and
a process of adhering the first resin layer and a second resin layer of a second laminated film including a second metal layer and the second resin layer laminated on the second metal layer to form a second exposed portion, where a part of the second metal layer is exposed, on one surface of the second metal layer in a state where the second laminated film is disposed to cause the second metal layer exposed at the second exposed portion to face the second polarity layer, wherein
a series of the process of depositing the first polarity layer, the process of depositing the solid electrolyte layer and the process of depositing the second polarity layer is repeated plural times.

26. The method for producing a lithium-ion rechargeable battery according to claim 25, wherein each of the first polarity layer, the solid electrolyte layer and the second polarity layer is deposited by a sputtering method.

27. The method for producing a lithium-ion rechargeable battery according to claim 26, wherein, in the deposition by the sputtering method, discharge and non-discharge are repeatedly performed in a short time.
